(19) United States
(12) Patent Application Publication
(10) Pub. No.: US 2015/0340828 A1
(43) Pub. Date: Nov. 26, 2015

(54) Method of Stranded Electrical Wire Connection

(71) Applicant: Jeremy Sviben, Medford Lakes, NJ (US)

(72) Inventor: Jeremy Sviben, Medford Lakes, NJ (US)

(21) Appl. No.: 14/715,694

(22) Filed: May 19, 2015

Related U.S. Application Data
(60) Provisional application No. 62/000,581, filed on May 20, 2014.

(51) Int. Cl. H01R 43/05; H01R 43/00; H01R 43/033

(52) U.S. Cl. CPC H01R 43/05; H01R 43/033; H01R 43/005

(57) ABSTRACT

A method of stranded electrical wire connection involves stripping the insulation off the ends of stranded wire and inserting a compression member, lined with solder or other low melting fusible material, over the ends of the wire, and applying constant, irreversible ratcheting pressure to the compression member to compress the compression member over each end of the stranded wires. The compressed stranded wires and compression member are inserted into a shrink tube containing adhesive. Heat is applied to the shrink tube to melt the adhesive and fusible material to form a permanent watertight wire connection. The wire connection is also waterproofed by spraying a sealant coating over the shrink tube.

### RELATED APPLICATION

This application claims the benefit of U.S. application Ser. No. 62/000,581, filed on May 20, 2014.

BACKGROUND OF THE INVENTION

A variety of methods are currently employed for attaching lengths of stranded electrical Wire. Most of these methods require that a portion of the insulation covering the end of the wire be stripped to expose the conductor strands of the wire. The exposed strands are then twisted, compressed, or otherwise manually secured together by means of a crimping tool, pliers, or even by hand. However, these methods, fundamentally, will not produce a secure stranded wire to stranded wire connection which will withstand stress forces which the wire connection experiences during use. Such wire connections are not secure and will eventually fail as a result of the naturally occurring conditions to which the connections are exposed.

More specifically, wires connected in this manner, when energized and then de-energized will create a heating and cooling effect, as the flow of current runs through the wires and is then turned off. This constant energizing and de-energizing of the wires causes intermittent expansion and then contraction of the wires. The endless cycle of expansion and contraction causes a constantly deteriorating effect on the wires which literally will destroy them in a relatively short period of time.

### SUMMARY OF INVENTION

U.S. Pat. No. 8,667,676 provides a method of stranded electrical wire connection which drastically reduces and eliminates the damaging heating and cooling effect in the connections, due to normal operation to the wires, yet caused by inconsistent tightening and crimping techniques. The method employs a ratcheting crimping tool which applies a designated, constant ratcheting compression to permanently connect stranded 8-18 gauge wires from lighting fixtures, including LED lamps, florescent lamps, and feed/power sources, by eliminating the spaces between the wire strands and thus eliminating the possibility of expansion and contraction between the strands during use. Application of the herein method eliminates the inconsistent and loose connections which result in ultimate untimely failure of electrical connections. The method is designed for use with stranded wire only, in low voltage, i.e. 30 volts or less, applications.

The method of the stranded electrical wire connection of the '676 patent involves stripping the insulation off the ends of stranded wire, inserting a metallic barrel member over the ends of the wire, applying ratcheting pressure to the barrel member to compress the barrel member over each end of the stranded wires, and then applying constant, irreversible ratcheting pressure to the wire containing barrel to substantially eliminate the spaces between the strands and to form a permanent barrel to wire connection between the lengths of wire. A shrink tube with an inner layer of adhesive is positioned over the permanent connection and the shrink tube, with its layer of adhesive, is heated, thus substantially eliminating any space between the shrink tube and the permanent connection. Utilizing this method results in a permanent, waterproof connection between the stranded wire which eliminates all expansion and contraction within the permanent connection during use.

The method of co-pending U.S. application Ser. No. 14/612,718 utilizes the same crimping tool concept of the '676 patent, but instead of heat shrink sealing the connection to make it waterproof, a dielectric gel filled box, cylinder, or coffin encases the crimped connection and is snapped and tightly closed over it. In another waterproofing method in lieu of heat shrink, the frayed ends of the wire are left extending out of the ends of the connection and a dielectric gel filled wire nut is twisted around the end of the connection.

One of the methods disclosed herein utilizes the same crimping concept of the '676 patent, but the metallic barrel member used in the process is solder lined and ultimately treated to ensure for a comprehensive heat shrink connection. The second method disclosed herein uses a spray crimped connection to create a rubber or similar, waterproof, coating.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the two lengths of stranded electrical wire to be connected in accordance with the method of the present invention.

FIG. 2 shows the first step of the method of the present invention, in which insulation has been removed.

FIG. 3 shows the strands of the lengths of wire after they are manually pressed together.

FIG. 4 shows the initial barrel member crimping step of the method of the present invention.

FIG. 5 shows the barrel member partially crimped around the strands of one end of one of the lengths of wire to be connected.

FIG. 6 shows the next steps of the method of the present invention showing the barrel members crimped over the strands of both of the ends of the lengths of wire to be connected.

FIG. 7 is a cross sectional view of the shrink tube, taken from FIG. 5.

FIG. 8 shows the next step of the method of the present invention, in which the shrink tube is introduced.

FIG. 9 shows the heating step of the first method of the present invention.

FIG. 10 shows the spraying step of the second method of the present invention.

### DETAILED DESCRIPTION OF THE INVENTION

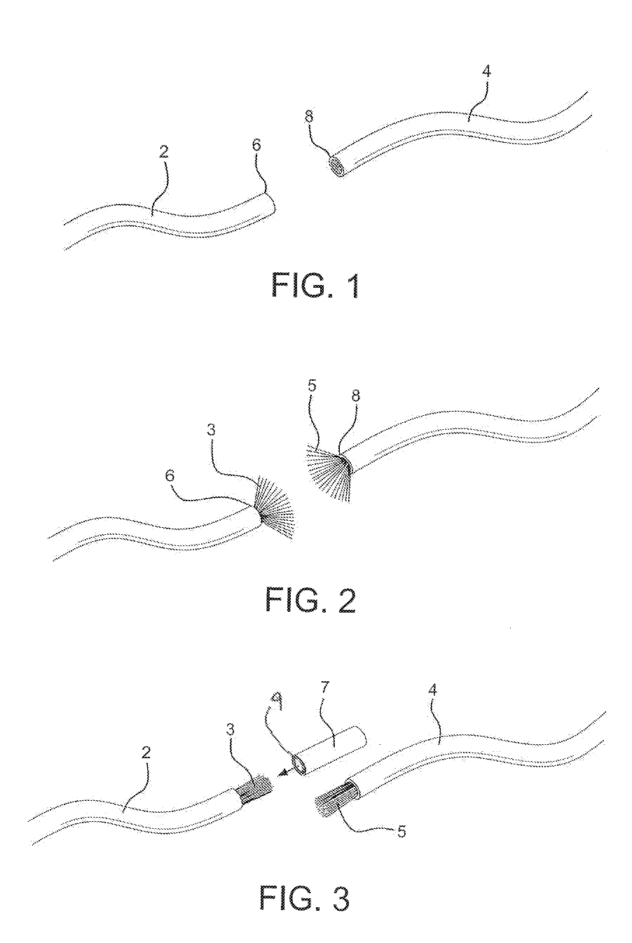

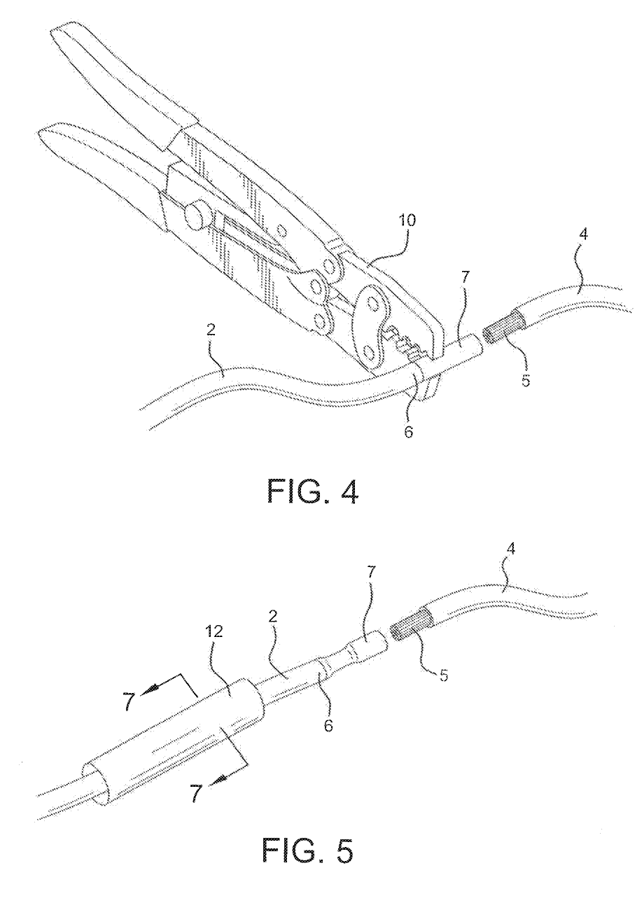

The object of the invention is to permanently connect lengths of stranded electrical wire in order to eliminate the possibility of expansion and contraction between the strands of the wire and thus ensure for the longevity of the connection. As seen in FIG. 1, insulated covered electrical stranded wires 2 and 4 with conductor strands 3 and 5, are provided for connection. Insulation is stripped off ends 6 and 8 of wires 2 and 4 to expose strands 3 and 5, as seen in FIG. 2. Strands 3 and 5 are initially gathered and manually pressed together. FIG. 3.

Metallic barrel member 7 is made of tin coated copper or equivalent material and is internally lined with solder 9 or equivalent low melting fusible alloy material used for joining metal. Barrel member 7 is inserted over pressed strands 3 (FIG. 3) and, by use of ratcheting crimper tool 10, constant, irreversible ratcheting pressure is applied to the barrel member to tightly compress the strands at end 6 of wire 2 together. Wire 2 can also be crimped under one pressure point. It has been found that ratcheting pressure, accomplished in distinct, irreversible rateheting intervals, will tightly compress the strands of the wire such that the spaces between the strands and the barrel member are substantially eliminated. A ratcheting crimper tool is used, since once the crimping process begins, this tool provides a constant pressure which will not reverse until the connection has been fully compressed or the tool's release button is pushed. This creates a consistent, increasingly tight, compressed wire connection regardless of the strength of the installer.

After strands 3 are sufficiently compressed within barrel member 7, shrink tube 12 is inserted over wire 2, as seen in FIG. 5. Shrink tube 12 is made of a rubberized material and, as best seen in FIG. 7, comprises an inner layer of adhesive 14. The adhesive is a thermoplastic type adhesive, or its equivalent, capable of being dissolved when heated to form a tight, gasket like seal.

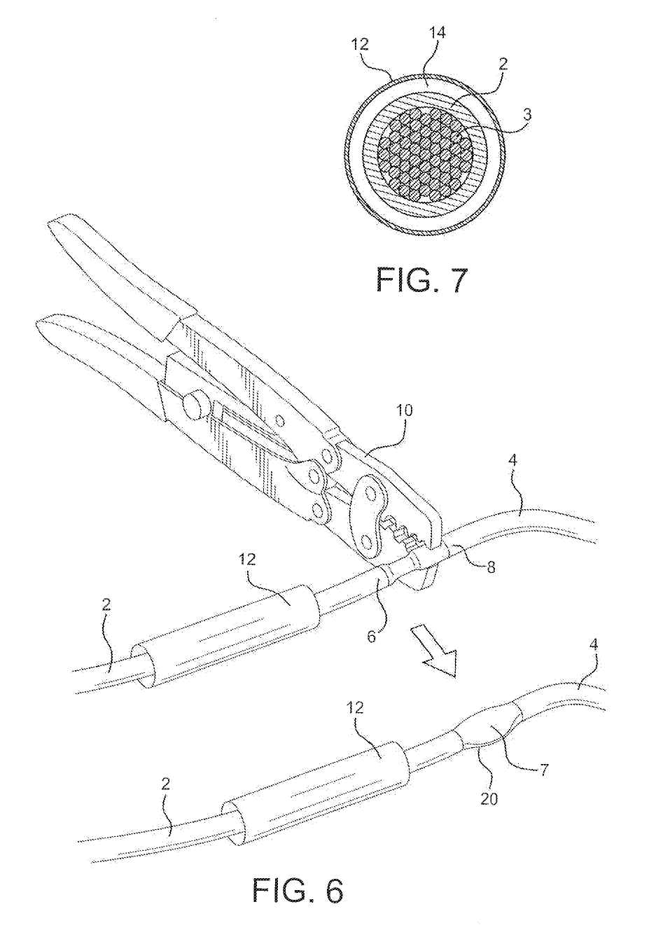

Strands 5 at end 8 of wire 4 are next inserted into barrel member 7. Barrel member 7 is then similarly compressed by ratcheting crimping tool 10, such that all strands 3 and 5 at ends 6 and 8 of both wires 2 and 4 are tightly compressed to eliminate all space between the strands and the barrel member. Thus, as seen in FIG. 6, permanent connection 20 is formed between wires 2 and 4.

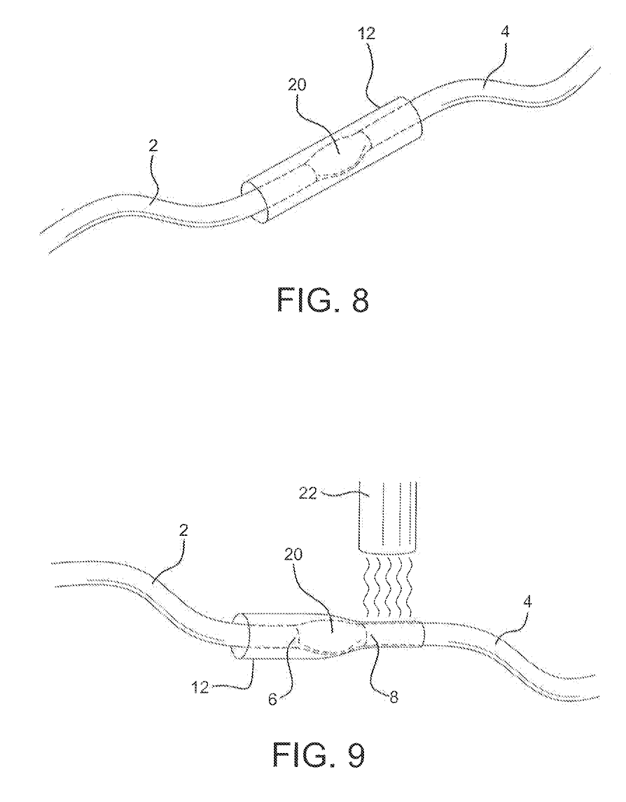

Shrink tube 12 is then slid over connection 20. See FIG. 8. As shown in FIG. 9, shrink tube 12 is heated, by heat source 22, to a temperature of between 150° F. and 200° F. This causes the inner adhesive within shrink tube 12 and solder 9 in barrel member 7 to melt and form a permanent, void filling waterproof gasket connection securely around ends 6 and 8 of wires 2 and 4 and connection 20. When shrink tube 12 and barrel member 7 are further heated to approximately 230° F., the tube and barrel member shrink to about one third their size, forming an abrasion proof, tension resistant waterproof jacket, to permanently surround and protect connection 20. It is contemplated that solder lined barrel member 7 could also be used independently of shrink tube 12.

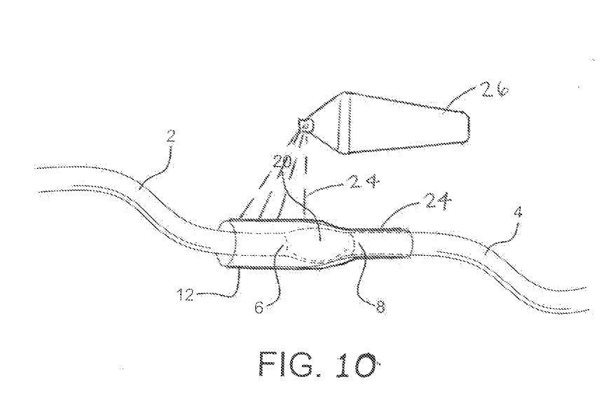

FIG. 10 illustrates the above described method, except for the application of a rubber or equivalent waterproof, sealant coating 24. In the embodiment shown in FIG. 10, coating 24 is applied over shrink tube 12 by means of spray from container 26 to create the permanent sealed, wire connection. Coating 24 may also be heat treated, depending on the coating material which is used.

It is contemplated that the method of the present invention can be used to connect 8-18 gauge stranded electrical wires which come from lighting fixtures, LED lamps, florescent lamps, and other feed power sources. However, wire of different gauges can successfully be used with this method. The type and size of the wires described herein should not he considered restrictive to the method of the invention. The herein method is directed for use with stranded wire only, for low voltage, i.e. 30 volts or less, applications.

Application of this method will result in electrical connections which can be buried in soil types ranging from acid to alkali. The connections which are made are especially important for use in the connection of current/voltage sensitive lighting sources such as LED lamps and low voltage lighting fixtures.

Certain novel features and components of this invention are disclosed in detail, in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. The method of insulated stranded electrical wire connection comprising the steps of:
providing separate lengths of stranded electrical wire to be connected;
stripping insulation off the ends of each of said lengths of wire to expose conductor strands;
pressing the exposed strands together so that the strands are intermeshed;
providing a compression member lined with a low melting fusible material;
inserting the compression member over the pressed, intermeshed strands;
applying constant pressure to the compression member in distinct, irreversible, ratcheting pressure intervals to tightly compress the exposed conductor strands of each length of wire within compression member;
continuing to apply constant pressure to the compression member in distinct, irreversible, ratcheting pressure intervals until all spaces between the strands and the compression member are eliminated, forming a secure connection between said lengths of wire with no spaces between the conductor strands and the compression member;
providing a shrink tube containing a layer of adhesive;
inserting the pressed, intermeshed strands and compression member into the shrink tube; and
applying heat to the shrink tube to melt the adhesive and fusible material to form a. permanent watertight connection between the wires.

2. The method as in claim 1 further comprising the step of providing a ratcheting crimping tool to apply the constant pressure.

3. The method as in claim 2 comprising the further step of applying the constant pressure in distinct ratcheting intervals by use of the crimping tool.

4. The method as in claim 1 comprising the further steps of inserting the exposed conductor strands of one of said lengths of wire into one end of the compression member and applying constant pressure to that end of the compression member and inserting the exposed conductor strands of the other of said lengths of wire into the other end of the compression member and applying constant pressure to that other end of the compression member to form a permanent connection between the lengths of wire.

5. The method as in claim 1 wherein in applying constant pressure the compression member and exposed conductor strands are subjected to increasingly tightened, irreversible compression.

6. The method as in claim 5 comprising the further step of providing a ratcheting crimper to apply the increasingly tightened, irreversible compression.

7. The method as in claim 1 wherein the compression member comprises a barrel member.

8. The method of insulated stranded electrical wire connection comprising the steps of:
providing separate lengths of stranded electrical wire to be connected;
stripping insulation off the ends of each of said lengths of wire to expose conductor strands;
pressing the exposed strands together so that the strands are intermeshed;
providing a compression member;
inserting the compression member over the pressed, intermeshed strands;
applying constant pressure to the compression member in distinct, irreversible, ratcheting pressure intervals to tightly compress the exposed conductor strands of each length of wire within compression member;
continuing to apply constant pressure to the compression member in distinct, irreversible, ratcheting pressure intervals until all spaces between the strands and the compression member are eliminated, forming a secure connection between said lengths of wire with no spaces between the conductor strands and the compression member;
providing a shrink tube containing a layer of adhesive;
inserting the pressed, intermeshed strands and compression member into the shrink tube; and
spraying a sealant coating onto the shrink tube to form a permanent, sealed, watertight connection between the wires.

9. The method as in claim 1 further comprising the step of providing a ratcheting crimping tool to apply the constant pressure.

10. The method as in claim 9 comprising the further step of applying the constant pressure in distinct ratcheting intervals by use of the crimping tool.

11. The method as in claim 8 comprising the further steps of inserting the exposed conductor strands of one of said lengths of wire into one end of the compression member and applying constant pressure to that end of the compression member and inserting the exposed conductor strands of the other of said lengths of wire into the other end of the compression member and applying constant pressure to that other end of the compression member to form a permanent connection between the lengths of wire.

12. The method as in claim 8 wherein in applying constant pressure the compression member and exposed conductor strands are subjected to increasingly tightened, irreversible compression.

13. The method as in claim 12 comprising the further step of providing a ratcheting crimper to apply the increasingly tightened, irreversible compression.

14. The method as in claim 8 wherein the compression member comprises a barrel member lined with a low melting fusible material.

15. The method as in claim 14 comprising the further step of applying heat to the coating to melt the adhesive and fusible material to form the watertight connection between the wires.
